(19) United States
(12) Patent Application Publication
(10) Pub. No.: US 2010/0080367 A1
(43) Pub. Date: Apr. 1, 2010

(54) PHONE-LINE POWERED LIGHTING DEVICES AND METHODS OF USING SAME

(75) Inventor: Michael Miskin, Sleepy Hollow, IL (US)

Correspondence Address: FACTOR & LAKE, LTD, 1327 W. WASHINGTON BLVD., SUITE 5G/H, CHICAGO, IL, 60607, US

(73) Assignee: LYNK LABS, INC., Elgin, IL (US)

(21) Appl. No.: 12/444,547

(22) PCT Filed: Oct. 5, 2007
(86) PCT No.: PCT/US07/21452

§ 371 Date: Apr. 30, 2009

Related U.S. Application Data
(60) Provisional application No. 60/849,964, filed on Oct. 5, 2006.
(60) Provisional application No. 60/964,998, filed on Aug. 16, 2007.

(51) Int. Cl. H04M 11/00

(52) U.S. Cl. 379/90.01

(57) ABSTRACT

A telephone service provider or alarm company, supplies phone-line-power for auxiliary, backup, and/or emergency lighting in residential, commercial and/or industrial facilities at a reasonable charge in exchange for providing, maintaining and ensuring that lighting service and power will be available when needed such as under power failure situations. A phone-line-driven lighting device includes a sensor capable of detecting a primary power source. Once the sensor senses that the primary power source is not present, circuitry connects the device's phone line terminal to a light producing element, in turn powering the light producing element via a telephone line's DC or AC power. Such a device may include a control circuit which responds to a predetermined phone line signal, thereby controlling the operational state of the device. Such a signal could be broadcast in emergency or other informative situation by the provider of the phone line service.

### CROSS REFERENCE TO RELATED APPLICATIONS

This application relies on the priority of U.S. Ser. No. 60/849,964, filed Oct. 5, 2006 and U.S. Ser. No. 60/964,998, filed on Aug. 16, 2007.

### TECHNICAL FIELD

The present application relates to devices powered by POTS phone lines; to provide auxiliary, emergency or backup lighting; and to services provided in connection with POTS lines.

### BACKGROUND OF THE INVENTION

Auxiliary, emergency, and backup lighting systems are currently available in many forms. Emergency lighting systems are more commonly found in commercial, industrial, and other non-residential environments. For the residential market, a backup lighting system is less common. Flashlights and/or candles are often used to provide light when the power fails in a home or residential building. Emergency and backup lighting systems are available with several differentiating features and may include photo sensors, power sensors and smoke and fire sensors to name a few. Most emergency lighting systems share some common system requirements, namely a battery backup. The emergency light operates in a standby mode with its lights off while being powered from a primary power source, usually the mains power lines, and only operates off of a battery backup when the main power source fails or smoke or fire is detected.

In the case of the residential market, flashlights and/or candles are most often used when the power fails. It's very common for a resident to find that the batteries in the flashlight(s) have discharged. In many cases it's also difficult for a resident to locate a flashlight in a time of need. This can be even more challenging for disabled and/or elderly people. Other than flashlights, emergency and/or backup lighting systems are not designed to be readily available to the residential consumer.

The battery or batteries for auxiliary or emergency lighting systems are either packaged with or otherwise integrated within the emergency lighting system fixture and/or housing, or are placed locally within the same room or building where the emergency lighting system resides. These batteries must be monitored, maintained, and replaced by the owner or operator of the facility where emergency lighting systems are used. This would be the same for emergency lights used in residential homes and buildings if they were available. The batteries in all of these systems will occasionally need to be disposed of and replaced with new ones.

Thus there is a need for better auxiliary, emergency, and backup lighting devices, and for more convenient, compact, affordable and reliable ways to power such devices. The present invention meets these needs and provides other advantages as will become apparent in the disclosure and claims below.

### SUMMARY OF THE INVENTION

The inventors of the present invention determined that it would be advantageous to provide a lighting device and/or emergency lighting system that does not require a battery backup, and can be integrated into a residential, commercial, and/or industrial setting. They also determined that that it would be advantageous if this lighting backup and/or emergency lighting system utilized DC or AC power from the telephone line and the phone line service provider as an alternative to local battery power which could fail, has to be monitored, maintained and/or replaced. Similarly it was determined that it would be advantageous if a provider, such as a telephone service provider or alarm company, would supply phone line powered backup and/or emergency lighting services to residential, commercial and/or industrial facilities at a reasonable charge. The provider would maintain the power source and ensure that lighting service and power will be available under power failure situations. Likewise it was determined that it would further be advantageous if a lighting device included a control circuit which responds to a predetermined phone line signal, thereby controlling the operational state of the device. Such a signal could be broadcast in emergency or other informative situations.

Hence, according to an embodiment of the invention a phone-line-driven lighting device is provided. The phone-line-driven device includes a sensor capable of detecting a primary power source. Once the sensor senses that the primary power source is not present, circuitry connects the device's phone line terminal to the light producing element, in turn powering the light producing element via the telephone line's DC or AC power.

According to an embodiment of the invention, a light producing element is at least one of an LED, halogen bulb, or incandescent bulb.

According to an embodiment of the invention a light producing element is driven by one of either DC or AC power from the phone line.

According to an embodiment of the invention, a phone-line-driven lighting device has circuitry that prevents AC ring voltage of the phone line from damaging a DC driven light producing element.

According to an embodiment of the invention, a phone-line-driven lighting device has an override switch which controls the operational state of the device.

According to an embodiment of the invention, a phone-line-driven lighting device has a control circuit which responds to predetermined phone line signals to control the operational state of the device.

According to an embodiment of the invention, a predetermined signal is generated by a phone line service provider and sent to a phone-line-driven device.

According to an embodiment of the invention, a phone-line-driven lighting device is integrated into a primary light source.

According to an embodiment of the invention, a primary light source has a terminal for connection to the primary power supply.

According to an embodiment of the invention, a phone-line-driven lighting device is integrated into the charging base unit of a cordless phone.

According to an embodiment of the invention, a phone-line-driven lighting device is integrated into a cover for a mains switch or power outlet.

According to an embodiment of the invention, a phone-line-driven lighting device is integrated into at least one of a charging base unit or a base station transmitter of a baby monitor.

According to an embodiment of the invention a phone-line-driven lighting device is integrated into a charging base unit of a rechargeable electronic product, or facsimile machine, a computer, a printer, or other such devices currently ported for both mains and POTs lines.

According to a method embodiment of the invention auxiliary, emergency or backup lighting is provided in the following manner, first sensing a failure or depletion of a primary power source; and then illuminating a lighting element with current from a phone line. In an embodiment of the invention, a method may include the step of switching the light producing element off when the primary power is again detected.

According to an embodiment of the invention, a method may include the step of powering the light producing element from the primary power source when the primary power source has power.

According to an embodiment of the invention a method of distributing power for emergency or auxiliary lighting in multiple locations, residences, buildings, or facilities comprises identifying customers desiring such lighting and allowing the customers to use the power from the POTS lines in return for a fee. In an embodiment, the distributor of power is an alarm company.

### DESCRIPTION OF THE DRAWINGS

FIG. 1 is a block diagram of an embodiment of a device according to the invention;

FIG. 2 is a block diagram of an embodiment of a device according to the invention;

FIG. 3 is a schematic view of an embodiment of the invention;

FIG. 4 is a schematic view of an embodiment of the invention; and,

FIG. 5 is a schematic view of an embodiment of the invention.

### DETAILED DESCRIPTION OF THE DRAWINGS

The Plain Old Telephone Service “POTS” hard-wired phone lines are specified as life lines. They operate on large batteries at the telephone company facility and are maintained and monitored to always provide power over the phone line to power a phone for emergency purposes. A POTS line will typically have approximately at least 50V DC at 10 mA of current, which is more than enough to power a significant amount of light when using for example low voltage efficient LED technology. Additionally, an AC voltage is also provided over a POTS line which rings the telephone, but could additionally be used to power a light source under the correct conditions.

Lights, such as LEDs, can be driven with low voltage AC or DC power based on the application and system requirements. Such LEDs have been designed into “EXIT” signs and other emergency lighting products that have battery backups.

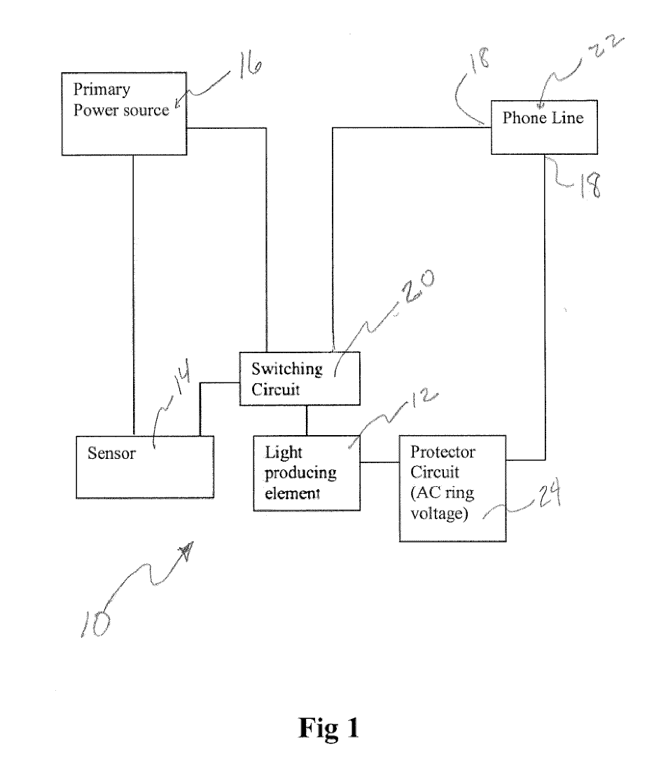

FIG. 1 discloses a phone-line-driven lighting device 10 according to the invention. The phone-line-driven lighting device 10 comprises a light producing element 12, a sensor 14 capable of detecting a primary power source, a primary power source 16, a terminal 18 for connecting the device to a phone line 22, and a switching circuit 20. The sensor 14 is connected to both the primary power source 16 and switching circuit 20. When the sensor 14 no longer detects the primary power source 16 (such as in power shut downs or failures), the switching circuit 20 electrically connects the phone line terminal 18 to the light producing element 12. The primary power source 16 may be AC mains voltage, such as standard power found in U.S. homes and businesses, or DC voltage. The light producing element 12 may be operated in optional embodiments, with a DC voltage from the phone line 22, AC or DC voltage from the primary power source 16, or the AC ring signal voltage available from POTS lines 22.

The terminal 18 can be any of a number of electrical connections such as standard telephone jacks, plugs, screw lugs, direct hard-wiring, soldering, clipping or any other standard or custom connection. The light producing element may be any of various types of electrical lighting known in the art, such as LEDs, incandescent bulbs, and halogen bulbs. Additionally, the phone-line-driven lighting device 10 may include protective circuitry 24 that prevents the AC ring voltage from damaging an LED when used as the light producing element 12.

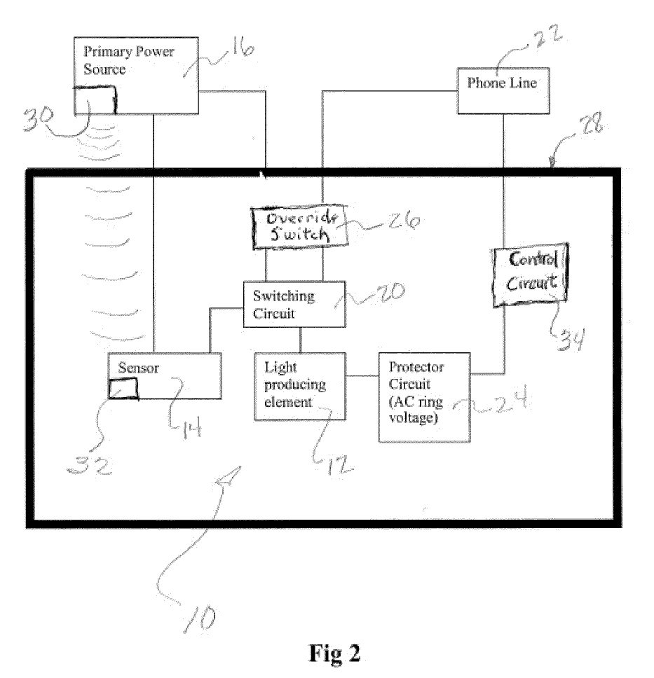

FIG. 2 discloses the phone-line-driven lighting device 10 similar to the one shown above in FIG. 1, but is integrated into device 28. The device 28 may be light fixtures (e.g. recessed lighting, track lighting, overhead lights, exit signs, wall sconces, free standing lamps, and the like) each having lights (aside from the light producing element 12) for standard use in illumination and a terminal connection to the mains power.

Even more advantageous because of the ease of consumer installation is the integration of device 10 into consumer products which already have both a mains connection and a phone line connection such as cordless phone base units, facsimile machines, printers, and computers. Still advantageous for their application, is the integration of device 10 into a standard phone, a baby monitor base unit or station. The phone-line-driven lighting device 10 may also be integrated into existing residential or commercial electrical fixtures such a cover for a mains switch or power outlet.

FIG. 2 discloses that device 10 may also contain an override switch 26 which controls the operation state of the device 10, e.g. lighting on/off. The override switch 26 may take the form of switches commonly found in the art, such as electrical and mechanical switches, analogue, or solid state.

FIG. 2 also discloses that optionally, in some embodiments, communication between the sensor 14 and primary power source 16 may be wireless, such as through infrared, and radio waves of various frequencies and bandwidth. Located at the primary power source 16, such as the transmitter being plugged directly into a mains wall socket, is a transmitter 30. Transmitter 30 while powered by the mains transmits for example a periodic signal to a receiver 32 located at, and in electrical connection with, sensor 14. The receiver 32 may be any standard wireless receiver known in the art. Other devices to wirelessly detect the presence or absence of the mains power could include induction coils and antennae placed within sufficient range of the mains wiring to inductively sense the AC voltage.

FIG. 2 discloses that optionally the device 10 may include a control circuit 34 which responds to predetermined phone line 22 signals to control the operational state of device 10 or light producing element 12. Such a signal could be sent by the phone line service provider in the event of an emergency or other event requiring broadcast notice. Lighting element 12 would visibly indicate the warning.

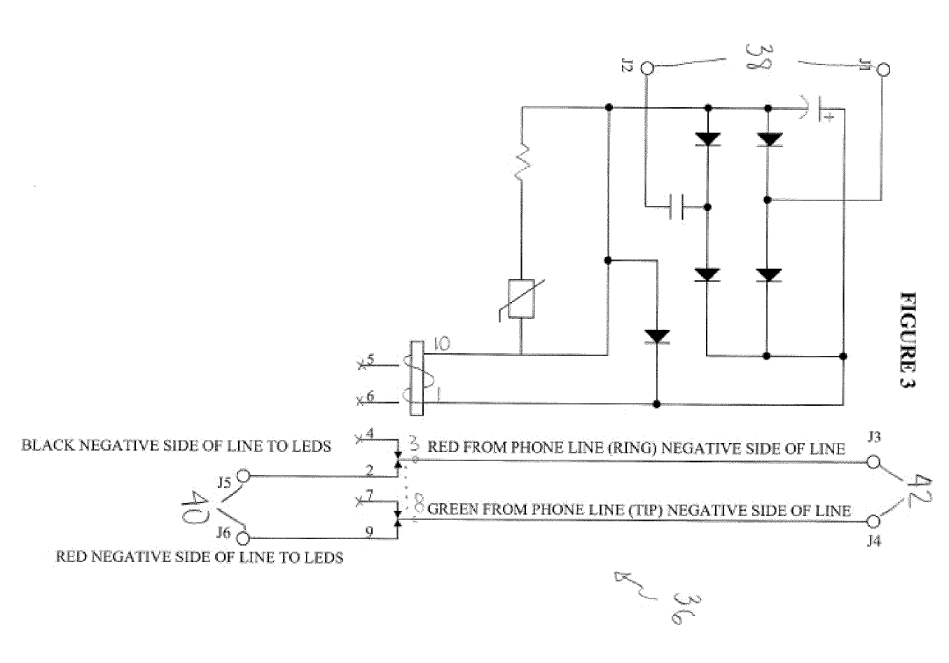

FIG. 3 discloses an exemplary circuit 36 for sensor 14 which has a first pair of terminals 38 for sensing the primary power source 16, a second pair of terminals 40 for connecting to a light producing element 12 and a third pair of terminals 42 for connecting to a telephone line 22.

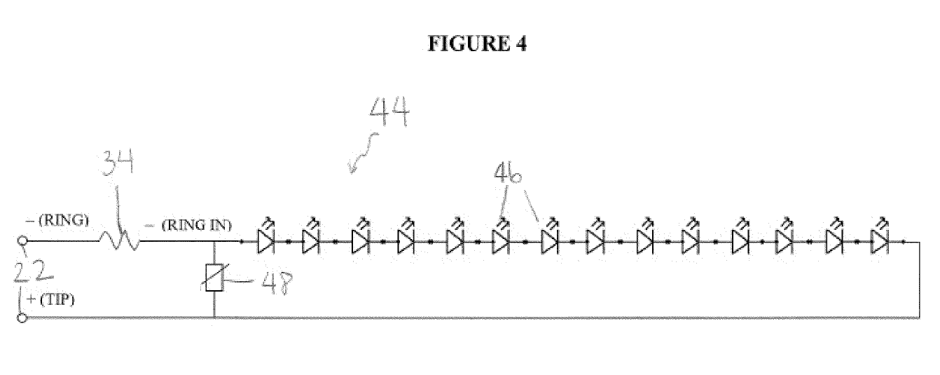

FIG. 4 discloses an exemplary schematic circuit 44 for switching circuit 20 according to the invention having LEDs 46 as a light producing element 12 and a variable resistor 48 “MOV” circuit for protecting the light producing element 12 from inbound AC ring voltages on the phone line 22.

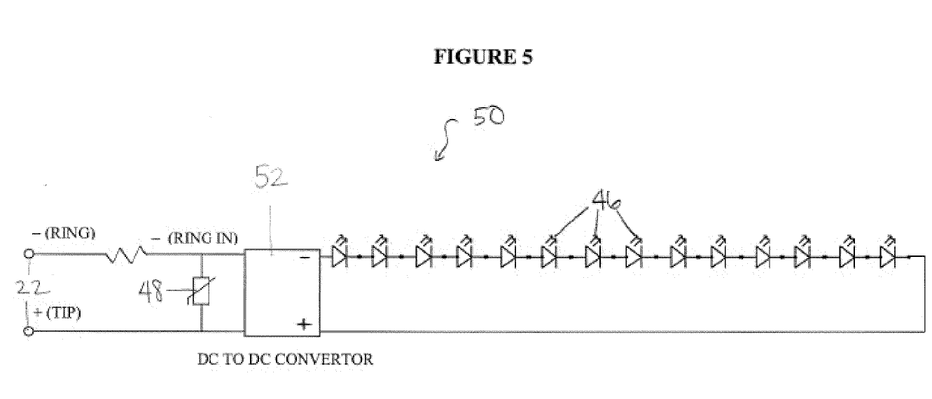

FIG. 5 discloses an exemplary embodiment of a light producing element 12 according to the invention that is identical to the light producing element 12 shown above in FIG. 4 but also includes a DC/DC converter 52. The DC/DC converter 52 may be used to convert the level of DC voltage delivered from phone line 22 to the light producing element 12 as well as improve efficiency of the device 10.

It is to be understood that additional embodiments of the phone-line-driven backup LED lighting system described herein may be contemplated by one of ordinary skill in the art in view of this disclosure and that the scope of the present invention is not limited to the embodiments disclosed. While specific embodiments of the present invention have been illustrated and described, numerous modifications can come to mind without significantly departing from the spirit of the invention, and the scope of protection is only limited by the scope of the accompanying claims.

What is claimed is:

1. A phone-line-driven lighting device comprising:
a. a light producing element;
b. a sensor capable of detecting a primary power source;
c. a terminal for connecting the device to a phone line; and
d. a circuit connecting the phone line terminal to the light producing element when the sensor no longer detects a primary power source.

2. The phone-line-driven lighting device of claim 1 wherein the sensor includes a receiver for receiving a wireless signal indicative of the presence of a primary power source.

3. The phone-line-driven lighting device of claim 1 including a transmitter which transmits a wireless signal from the primary power source.

4. The phone-line-driven lighting device of claim 1 wherein the light producing element is at least one of an LED, halogen bulb, or incandescent bulb.

5. The phone-line-driven lighting device of claim 1 wherein the light producing element is driven by one of either DC or AC power from the phone line.

6. The phone-line-driven lighting device of claim 1 having circuitry that prevents AC ring voltage of the phone line from damaging a DC driven light producing element.

7. The phone-line-driven lighting device of claim 1 having an override switch which controls the operational state of the device.

8. The phone-line-driven lighting device of claim 1 having a control circuit which responds to predetermined phone line signals to control the operational state of the device.

9. The phone-line-driven lighting device of claim 8 wherein the predetermined signal is generated by a phone line service provider.

10. The phone-line-driven lighting device of claim 1 being integrated into a primary light source.

11. The phone-line-driven lighting device of claim 10, the primary light source having a terminal for connection to the primary power supply.

12. The phone-line-driven lighting device of claim 1 being integrated into the charging base unit of a cordless phone.

13. The phone-line-driven lighting device of claim 1 being integrated into a cover for a mains switch or power outlet.

14. The phone-line-driven lighting device of claim 1 being integrated into at least one of a charging base unit or a base station transmitter of a baby monitor.

15. The phone-line-driven lighting device of claim 1 being integrated into a charging base unit of a rechargeable electronic product.

16. A method of providing auxiliary lighting when a primary power source fails comprising the steps of:
a. sensing the failure of a primary power source; and
b. illuminating a lighting element with current from a phone line

17. The method of claim 16 including the step of switching the light producing element off when the primary power is again detected.

18. The method of claim 16 including the step of powering the light producing element from the primary power source when the primary power source has power.

19. A method of distributing power from the POTS for emergency, auxiliary, or backup lighting to multiple locations, residences, buildings, or facilities comprising:
identifying customers desiring such lighting and allowing the customers to use the power from the POTS lines in return for a fee.

20. The method of claim 19 where the distributor of power is an alarm company, and including the step of providing security alarm services over the POTS lines for a fee.

21. The method of claim 19 including the step of registering a lighting device with the telephone line lighting service provider over the telephone line when the phone-line-driven lighting device is connected to the line.
